(19) United States
(12) Patent Application Publication
(10) Pub. No.: US 2025/0076479 A1
(43) Pub. Date: Mar. 6, 2025

(54) METHOD FOR DETERMINING TARGET INFORMATION OF RADAR TARGETS OF A RADAR SYSTEM, AS WELL AS RADAR SYSTEM AND VEHICLE COMPRISING A CORRESPONDING RADAR SYSTEM

(71) Applicants: Volkswagen Aktiengesellschaft, Wolfsburg (DE); Fraunhofer Gesellschaft zur Förderung der angewandten Forschung e.V., Munich (DE)

(72) Inventors: Heiko Gustav Kurz, Hannover (DE); Marc-Michael Meinecke, Sassenburg (DE); David Mateos-Nunez, Alcala de Henares (ES); Renato Simoni, Bonn (DE); María Antonia González-Huici, Bonn (DE)

(21) Appl. No.: 18/815,711

(22) Filed: Aug. 26, 2024

(30) Foreign Application Priority Data
Sep. 1, 2023 (DE) 102023208463.5

(51) Int. Cl. G01S 13/00; G01S 7/40; G01S 13/42; G01S 13/931

(52) U.S. Cl. CPC G01S 13/003; G01S 7/40; G01S 13/426; G01S 13/931

(57) ABSTRACT

A radar system for determining target information of radar targets includes a first antenna array configured to emit a transmit signal and receive a first signal reflected by a radar target, and a second antenna array configured to receive a second signal reflected by the radar target. The system is configured to process the received signals to determine distance information and angle hypotheses associated with the radar target. Based on the distance information and angle hypotheses, the system applies optimal filters to generate target information related to the radar target. The disclosure also relates to a vehicle incorporating such a radar system.

### RELATED APPLICATIONS

The present application claims priority to German Patent Application No. 10 2023 208 463.5, to Kurz, et al., filed Sep. 1, 2023, the contents of which is incorporated by reference in its entirety herein.

### TECHNICAL FIELD

The present disclosure relates to a method for determining target information of radar targets in a radar system. In this method, at least one transmit signal is emitted into an environment by a first antenna array of the radar system. A first receive signal, which is reflected by a radar target in the environment and based on the emitted transmit signal, is received by the first antenna array. Additionally, a second receive signal, also reflected by the radar target and based on the emitted transmit signal, is received by a second antenna array, which differs from the first antenna array.

The present disclosure further relates to a radar system comprising a first antenna array, at least one second antenna array, and an electronic evaluation unit.

This disclosure also relates to a vehicle comprising such a radar system.

### BACKGROUND

Radar information plays an important role in highly automated vehicles, which incorporate a variety of driver assistance systems or vehicle guidance systems. These assistance systems, in particular, rely on radar information to execute at least semi-autonomous driving maneuvers.

For example, JP 2005 233 723 A discloses a radar device that includes distributed antennas. A radar control device can extract received digital data based on the reception time. Digital beamforming processing can then be performed using position information, derived from the transmitted digital data and the received time information, to obtain the extracted received digital data. Subsequently, beam combining can be performed to detect and display the target.

Additionally, CN 110 412 559 A describes a non-coherent fusion target detection method for a distributed drone MIMO radar. Initially, the position and target speed of a search base point are established, with this point serving as a center to create a four-dimensional search grid. The entire search area is then traversed to obtain range Doppler information of a target. Based on this, each receiver of the distributed drone MIMO radar conducts matched filtering processing on the received echo signals and extracts the echo signals transmitted by different platforms.

WO 2018 158 281 A1 further discloses a method and device for capturing the surroundings of a moving object, such as a vehicle.

### SUMMARY

According to some aspects of the present disclosure, the target acquisition or detection capabilities of a radar system, particularly one with antenna elements or arrays that are incoherent with respect to each other, are enhanced. This improvement specifically aims to increase the resolving power or angular resolution of the radar system.

Certain aspects of the present disclosure are outlined in the independent claims, with further implementations and preferred embodiments detailed in the dependent claims.

Advantageous exemplary embodiments of one aspect may also be considered advantageous for other aspects, and this applies conversely as well.

For example, the radar system and/or the vehicle may include technical means for performing or enabling the method.

In some examples, a method is disclosed for determining target information of radar targets in a radar system. In this method, at least one transmit signal is emitted into an environment by a first antenna array of the radar system. A first receive signal, which is reflected by a radar target in the environment and based on the emitted transmit signal, is received by the first antenna array. Additionally, a second receive signal, also reflected by the radar target and based on the emitted transmit signal, is received by a second antenna array that differs from the first array.

In the next steps, at least one piece of distance information between the first antenna array and the radar target is determined based on the transmit signal and the first receive signal. A first angle hypothesis for the first antenna array is then provided based on the first piece of distance information. Using the first piece of distance information and the first angle hypothesis related to the first antenna array, a second piece of distance information and a corresponding second angle hypothesis are determined for the second antenna array. Subsequently, a first optimal filter is determined based on the first piece of distance information and the first angle hypothesis, and/or a second optimal filter is determined based on the second piece of distance information and the second angle hypothesis. Finally, at least one piece of target information relating to the radar target is determined based on the first and/or second optimal filters.

This method can be advantageously used to enhance the target acquisition capabilities of a radar system. Specifically, the accuracy of target acquisition or detection of radar targets, such as objects in the radar system's environment, can be improved.

Another aspect of the present disclosure relates to a radar system comprising a first antenna array, a second antenna array, and an electronic evaluation unit, where the radar system is designed to execute the methods described herein.

The radar system may be configured as an electronic radar device or radar unit capable of detecting or acquiring radar targets in an environment. The radar system may include multiple antenna arrays, which can be collectively referred to as an antenna arrangement. These antenna arrays may each consist of several transmit and receive elements, allowing for comprehensive acquisition, such as 360-degree acquisition, of the surrounding area using the radar system described herein.

The electronic evaluation unit may be configured as an electronic processing system. It could be configured as a distributed system, with parts of the evaluation unit arranged within individual antenna arrays to perform corresponding pre-processing operations. Alternatively, the electronic evaluation unit could be configured as a central system, communicatively linked to the respective antenna arrays, enabling it to carry out corresponding evaluations of target information.

In one exemplary embodiment of this aspect, the first and second antenna arrays are spaced apart. The spacing allows for broader coverage with fewer antenna arrays, which is particularly advantageous in the automotive field, where antenna arrays can be placed in various locations on or within a motor vehicle to facilitate 360-degree acquisition of the vehicle's surroundings. Even with irregular or non-equidistant spacing of the antenna arrays, the method described herein enables effective determination of radar information, making it highly suitable for automotive applications.

Another aspect of the present disclosure relates to a vehicle equipped with the radar system described herein or an advantageous refinement thereof. The radar system can be integrated into the vehicle to detect its surroundings, which is particularly beneficial for driver assistance systems or autonomous vehicle systems.

The disclosed radar system and vehicle may include features that enable the method's implementation, ensuring seamless operation across various applications.

In situations not explicitly described herein, the method may include outputting an error message, requesting user feedback, or setting a default configuration or initial state.

The present disclosure also encompasses refinements of the radar system and the vehicle, which include features already described in connection with the method. Therefore, these refinements are not repeated here.

Moreover, the present disclosure covers combinations of features from the described embodiments.

### BRIEF DESCRIPTION OF THE DRAWINGS

Exemplary embodiments of the present disclosure are described hereafter. In the drawings:

FIG. 1 illustrates an exemplary radar system used on a vehicle, according to some aspects of the present disclosure;

FIG. 2 illustrates a schematic representation of two antenna arrays of the radar system from FIG. 1 in a far field configuration, according to some aspects of the present disclosure;

FIG. 3, in contrast to FIG. 2, illustrates the case of a near field acquisition configuration, according to some aspects of the present disclosure;

FIG. 4 illustrates a schematic flow for determining a portion of target information of the radar system from FIG. 1, according to some aspects of the present disclosure;

FIG. 5 illustrates a continuation of the embodiments from FIG. 4 with an additional function of an orthogonal matching pursuit algorithm, according to some aspects of the present disclosure;

FIG. 6 illustrates another schematic embodiment for determining a portion of target information or carrying out an angle estimation of incoherent antenna arrays, according to some aspects of the present disclosure; and

FIG. 7, proceeding from FIG. 1, illustrates the respective fields of vision, which overlap, for various antenna arrays, according to some aspects of the present disclosure.

### DETAILED DESCRIPTION

The exemplary embodiments described hereafter are preferred exemplary embodiments of the present disclosure. In the exemplary embodiments, the described components in each case represent individual features of the present disclosure that are to be considered independently of one another. Each feature also refines the present disclosure independently of one another and, as a result, shall be considered an integral part of the present disclosure, either individually or in a combination other than the one shown. Furthermore, the described exemplary embodiments can also be supplemented with additional features disclosed herein.

In the figures, functionally equivalent elements are each denoted by the same reference numerals.

When a radar system is used in the automotive field, for example, precise, improved, and nonetheless simpler detection of objects is needed. Enhanced detection performance and a reduced side lobe ambiguity in conjunction with a high angular resolution of the radar system are important, for example, for lane guidance, for carrying out a passing maneuver, or for obstacle detection. This is where the present disclosure advantageously comes in and can remedy the situation in this regard.

Typically, the angular resolution can be improved with bistatically distributed systems and large coherent apertures. This approach, however, is associated with several challenges, which can be addressed by the methods and technologies described herein.

Bistatic configurations with coherent processing avoid the need for a shared local oscillator due to correlation with the transmit signal of an antenna of the radar system. However, such propagation channels can be impaired by unknown transmission functions due to active elements, which may be limited by the fields of vision, making it necessary to pre-measure the spacing or time delay between the antenna arrays with wavelength accuracy. This accuracy is required to estimate the filament offset, which is difficult to obtain and exposed to vibrations and deformations. Another issue with large coherent apertures is the need for high-frequency synchronization, which places great demands on the calibration of phase imbalances and antenna positions while being sensitive to vibrations and deformations. As a result, the methods described herein do not require large coherent apertures. Existing systems require significant computing resources for angle processing, particularly when the array geometry is unsuitable for Fast Fourier transform (FFT) processing.

Another challenge resolved by the methods described herein is the intrinsic calibration of phase imbalances for radar systems with large apertures, which are sensitive to squints of the calibration targets and necessitate an auto-calibration method. These auto-calibration methods allow simultaneous estimation of the phase imbalance of the channels, antenna positions, and angles of the calibration targets, presenting a multi-dimensional problem that suffers from ambiguity and may not be robust against deviations in parametric models, such as mutual coupling of uneven polarization.

These challenges can be addressed, either partly or entirely, by the solutions provided herein. By utilizing these methods, an incoherent combination of monostatic and bistatic signals can be carried out. Through the coupling between the range or distance and angle of a radar target, an improved determination of target information, such as angular resolution, can be achieved, particularly through sequential estimation.

For instance, optimizing antenna positions in mutual incoherent array configurations can be accomplished with incoherent beamforming, effectively addressed by the techniques described herein. The individual apertures or antenna arrays can be designed to be very sparse relative to each other, with high side lobes. By combining and averaging these side lobes, a higher resolution can be achieved at a favorable side lobe level. Unlike traditional methods, the present disclosure does not require that the target be detectable, correctly assigned between the individual orifices of the antenna arrays, or visible with a similar signal-to-noise ratio (SNR) from the various orifices. For example, systems and algorithms for azimuth and elevation estimation that utilize road reflections to increase vertical resolution, including phase combination from several orifices, can be enhanced through the disclosed methods.

A processing chain with distance mapping between orifices, that is, at the individual antenna elements of the antenna arrays, can be provided based on the angle hypothesis and sequential angle estimation, as described herein. In this way, the residual for each range field can be updated. In addition to its application in automotive radar systems, incoherent beamforming can also be applied in other fields, such as aerospace or automation. According to the present disclosure, at least one portion of target information may be based on a sparse reconstruction algorithm, such as the block orthogonal matching pursuit (BOMP) or block nearly orthogonal matching pursuit (block NOMP) algorithm.

The techniques described herein can also be employed in distributed radar systems with multi-configurations or bistatic configurations. Multi-way or multi-path approaches, as well as bistatic approaches with coherent phases, can be used to increase resolution or resolving power. In these implementations, a combination of one or more radar sensors and one or more transceivers, known as repeater tags, may be utilized. In a MIMO sensor and repeater tag configuration, the repeater tag receives the echo of the target and sends it back in amplified form with a frequency shift to the receiver of the original sensor, which tracks the target's path. This bistatic path can be identified based on the frequency shift. The bistatic path between the sensor and the repeater tag remains coherent, resulting in a virtual array that maintains the virtual TX-RX pairs of the sensors, plus a virtual repetition of the transmitter, at a distance dependent on the range of the repeater tag and the angle of the target. Since the combined virtual array has a length corresponding to the range of the repeater tag, the aperture is increased, theoretically enhancing resolution. However, this approach introduces certain challenges, which are addressed by the methods described herein.

The distance between the repeater tag and the sensor must be known with wavelength accuracy. This level of accuracy is achievable for short ranges, leading to a significant improvement in resolution, as even a few centimeters can suffice. If the range is larger, however, deformations and vibrations may impair the radar system's performance. Another issue is the gap in the virtual aperture, which can cause high side lobes and potentially obscure targets. Additionally, performance may degrade if there are numerous targets, as the bistatic distance range, even if separated from the monostatic path by a frequency shift, may coincide with the monostatic distance range of another target.

These challenges are addressed by the solutions described herein, which avoid performing correlations with bistatic signals using a transceiver, thereby resolving the associated issues.

Furthermore, some distributed systems avoid the use of a shared local oscillator by utilizing bistatic signal processing while preserving phase information. In these systems, the bistatic feedback of the target is coded with crosstalk channels, which must be measured for estimating the phase offset. This requires prior measurements of the distance between the individual antennas with wavelength accuracy. Unknown transmission functions may also affect this propagation channel, especially when the field of vision is restricted. The solutions provided herein address these issues by using distance-angle coupling, enabling target acquisitions or determinations of target information even with an incoherent arrangement of antennas within the radar system. When the combined distance between the individual antennas is greater than the distance due to a geometric near field or near field path, the methods described herein can be advantageously employed.

Additionally, systems that use standard three-dimensional FFT processing for cascaded, adjoining radar systems are limited in their use of separate apertures. The methods described herein are particularly suited for radar systems with separate apertures or apertures arranged at a distance.

Existing systems often utilize approaches for the fusion of multiple multimodal sensors, combining information at the level of estimations over time, such as through Kalman filtering or particle filtering. In contrast, the solutions provided herein involve combining spectra across complementary orifices.

The technology and methods described here can, in particular, be implemented as computer-implemented solutions.

With these solutions, it is possible to determine target information or radar information of radar targets within a radar system, which can be particularly beneficial when applied in a vehicle.

The radar system can comprise several distributed antenna arrays. An antenna array, which can also be referred to as an aperture or an antenna aperture or an array aperture, can be a surface area or a predefined area on which or within which several or a plurality of individual antennas or antenna elements are arranged. Above all, signals can be emitted, and signals can be received with the aid of an antenna array.

In the environment of the radar system, at least one transmit signal or multiple transmit signals can be emitted. When at least one of these transmit signals, such as, for example, the at least one transmit signal, impinges on a radar target, such as an object in the environment, this signal is reflected and returned in the direction of the radar system. Multiple reflected signals can be radiated or sent back. At least one first receive signal can be received by way of the first antenna array, and at least a second receive signal can be received by way of the second antenna array. In other words, a signal can be emitted with the aid of an antenna array, which can, in turn, be received by two or more antenna arrays. In this process, the first antenna array experiences a monostatic return of the signal, as the transmit signal was emitted and also received by the first antenna array. Bistatic signal return occurs in the case of the second antenna array, as the transmit signal was not necessarily emitted by the second antenna array.

A first portion of distance information can be determined, for example, based on the Doppler effect on the basis of the monostatic signal return relating to the first antenna array. A portion of distance information refers to the distance or range between the first antenna array and the radar target. Likewise, it is possible, of course, for several transmit signals and corresponding receive signals to be received. This allows multiple radar targets to be evaluated accordingly.

Based on the first portion of distance information, and thus a first Doppler effect determination, several angle hypotheses, that is, mathematical hypotheses, may be established with respect to the radar target. In particular, at least one angle hypothesis can be established or provided for each portion of distance information determined by the first antenna array. Since the second antenna array only receives the received signal and has not emitted a corresponding transmit signal, it is now possible, based on the first portion of distance information and the first angle hypothesis, to carry out a correlation to obtain a corresponding second portion of distance information for the second antenna array. In other words, the portion of distance information between the second antenna array and the radar target is estimated or determined based on the information relating to the first antenna array. In this way, a second portion of distance information corresponding to the first portion of distance information can be determined. Similarly, a second angle hypothesis corresponding to the first angle hypothesis is determined. The advantages of the methods described herein are evident, as a corresponding distance and angle determination was carried out for one antenna array and is utilized for further antenna arrays.

In this way, a target determination can be carried out for each antenna array in a very simple manner, even in the case of an incoherent antenna array, since corresponding information can be shared.

A respective optimal filter, often referred to as a “matched filter,” can be generated or determined for the first and/or second antenna arrays and the corresponding portions of radar information from these arrays. This allows for the optimal filtering of the relevant information from each antenna array. For example, a generalization of the average matched filter can be performed based on the two optimal filters or for the respective optimal filters of all antenna arrays. This generalized filter can then be used, for instance, to carry out the determination of target information, such as angle estimation.

An antenna array can be referred to as an antenna arrangement, which is preferably designed as a planar arrangement of antennas. The antenna arrays can consist of differently arranged transmit and/or receive antennas. In particular, these antenna arrays can be thinned-out or sparsely populated, which is especially advantageous when using the radar system in the automotive field. Specifically, for 360-degree acquisition of the vehicle's environment, antenna arrays may need to be positioned in various and differently configured areas on or within the vehicle.

In some examples, the first portion of distance information is determined using a Fast Fourier Transform (FFT). Based on the information from the received signals, it is possible, for example, to carry out a distance Doppler determination for each antenna array, and thus a distance determination based on the Doppler effect. To enable efficient calculations, particularly mathematical transformations such as FFT can be employed.

Other mathematical operations or transformations can also be utilized as needed.

The false alarm rate (FAR) is an important metric for assessing the performance of a radar system. Echo signals are detected against background noise during radar reception, where noise signals can statistically mimic useful signals, leading to the display of incorrect radar targets. The false alarm rate refers to the average number of incorrect targets that may be detected over a certain period, for example, per antenna revolution or per pulse succession period, at the receiver output of the radar system. The constant false alarm rate (CFAR) can be employed as a measure during the acquisition or detection of radar targets, adjusted according to the ambient conditions surrounding the radar system. This approach improves the suppression of false alarms, particularly in the near field, thereby enhancing target identification and increasing the radar system's range.

In some examples, an extrinsic calibration is performed on the first and/or second antenna arrays to determine the second portion of distance information and the second angle hypothesis for the second antenna array based on this calibration. This step is necessary because a coordinate transformation or the establishment of a shared coordinate system between the first and second antenna arrays is required to accurately determine the corresponding distance and angle information. To synchronize the two antenna arrays for this calculation, an appropriate calibration, particularly an intrinsic calibration, is performed. The extrinsic calibration allows for the spatial position and orientation of the first and second antenna arrays to be unified within a reference coordinate system. For example, a shared reference coordinate system can be used to convert the distance information and angle hypotheses from the first antenna array to the second.

In some examples, it is checked whether the first antenna array has been intrinsically calibrated, and if so, the second antenna array is calibrated based on a cooperative auto-calibration method, using the first array as a reference. Intrinsic calibration involves mapping three-dimensional points in the radar system's coordinate system onto a two-dimensional sensor, corresponding to the antenna arrays. If the first antenna array is already calibrated, the second and other antenna arrays of the radar system can be calibrated simply by referencing the calibrated first antenna array. In this manner, once one antenna array is calibrated, a cooperative auto-calibration method can efficiently calibrate the remaining arrays, enhancing the accuracy of target detection and the precision of the determined target information.

The use of the cooperative auto-calibration method is particularly beneficial in distributed antenna arrays in automotive applications. Depending on the number of antenna arrays and their placement on the vehicle, one array can be calibrated initially, and the remaining arrays can then be automatically calibrated based on the previously calibrated array.

In some examples, it is verified whether the determined second angle hypothesis lies within the field of vision of the second antenna array. If it does, the target information is determined based on the first and second optimal filters. The field of vision refers to the angular area within which an optical device, such as a radar system, can perceive and record changes or events. An angle hypothesis is used to estimate the angle at which a radar target may be located relative to the radar system. If the second angle hypothesis falls outside the field of vision, it cannot be used to determine target information, and the determination will rely solely on the information from the first antenna array.

In some examples, a first antenna signal from the first antenna array is determined based on the first portion of distance information and antenna information related to the elements of the first array, while a second antenna signal from the second antenna array is determined based on the second portion of distance information and antenna information from the second array. These antenna signals, derived from the respective antenna arrays, are used in further processing steps to simplify the determination of target information.

In some examples, the first optimal filter for the first antenna array is determined based on the first antenna signal and a predefined model of the spatial area of the first array. This generates an optimal filter tailored to the first array, distinguishing between near field and far field detections. The radar target's location, whether in the near or far field, determines the model used, such as a near field or far field vector model (also known as a steering vector model), in the filter's determination. Similarly, the second optimal filter is determined based on the second antenna signal and a predefined model of the boundary area of the second antenna array.

Additionally, nominal or calibrated antenna positions of the individual elements in the first or second antenna arrays may be considered when determining the optimal filters. Phase asymmetries or imbalances in these arrays can also be factored into the filter's calculation.

In some examples, a near field vector model or a far field vector model is provided as a predefined model of the spatial area for the first and second antenna arrays. Depending on whether a near or far radar target is acquired, the appropriate model is used for calculation.

A near field, also known as the reactive near field, refers to the region immediately surrounding an antenna, such as an antenna array. The far field, or Fraunhofer region, is the area where electromagnetic waves propagate as planar waves, independent of the antenna.

In some examples, the first antenna signal is filtered using the first optimal filter, and the second antenna signal is filtered using the second optimal filter. The target information is then determined based on these filtered signals. This process allows the radar system to estimate angles or other target information accurately.

In some examples, an orthogonal matching pursuit algorithm is used to determine the target information. This sparse approximation algorithm uses distance information, angle hypotheses, and optimal filters to derive the corresponding target information.

Finally, in some examples, the target information includes an angle and/or direction relative to the radar target. This angle estimation is particularly relevant for assessing the environment around a vehicle, aiding in the accurate determination of the radar target's position and movement.

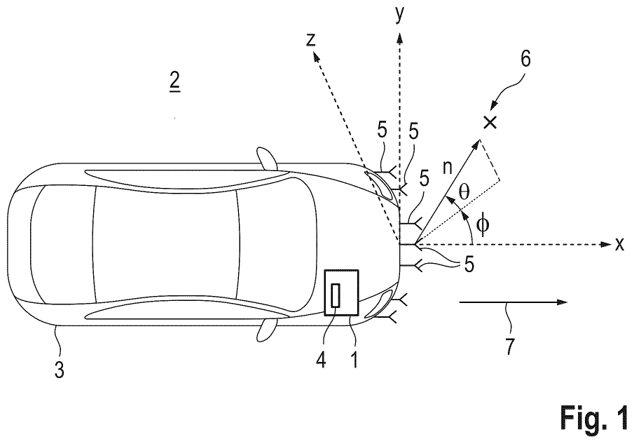

FIG. 1 illustrates a schematic representation of a radar system 1. The radar system 1 may be used particularly for environment detection, allowing radar targets or objects in the environment 2 of the radar system 1 to be acquired or detected. In this example, the radar system 1 is utilized in the automotive field. The radar system 1 is arranged in or integrated into a vehicle 3, specifically a motor vehicle. This configuration allows the radar system 1 to detect the vehicle environment 2, which is particularly advantageous for driver assistance systems, including those designed to carry out at least semi-autonomous interventions.

The radar system 1 may include an electronic evaluation unit 4 for processing information, data, and/or signals.

Additionally, the radar system 1 may comprise a plurality of antenna arrays 5, also referred to as antenna apertures. As shown in this example where the radar system 1 is used in a vehicle 3, the antenna arrays 5 are positioned in the front region of the vehicle. Similarly, additional antenna arrays 5 may be arranged around the periphery of the vehicle's body.

The antenna array 5 may be configured as an antenna arrangement, particularly an irregular, sparsely populated arrangement. The distances between the individual antenna arrays 5 may be non-equidistant.

Each antenna array 5 may comprise multiple individual transmit and/or receive antennas.

For instance, a radar target 6, such as an object in the environment 2, may be located ahead of the vehicle 3, particularly in the driving direction 7. This radar target 6 could represent a potential collision or interfering object relative to the vehicle 3, which must be detected as efficiently and accurately as possible. The radar system 1, as disclosed herein, is used for this purpose. For example, a distance n between at least one antenna element and the radar target 6 can be determined using the radar system 1. Additionally, an azimuth angle @ can be calculated. As illustrated in FIG. 1, a polar angle θ can also be determined. These are example variables that can be used to establish or determine the distance, direction, and/or angle relative to the vehicle 3 and the radar target 6.

The radar system 1, as disclosed herein, utilizes an incoherent combination of monostatic and bistatic radar echoes or signals via the antenna arrays 5 for acquiring or detecting the radar target 6, particularly for determining a portion of target information related to the radar target 6. For this purpose, a generalization of the average matched filter is applied for a possible subsequent angle estimation, where the coupling between distance and angle is considered and utilized.

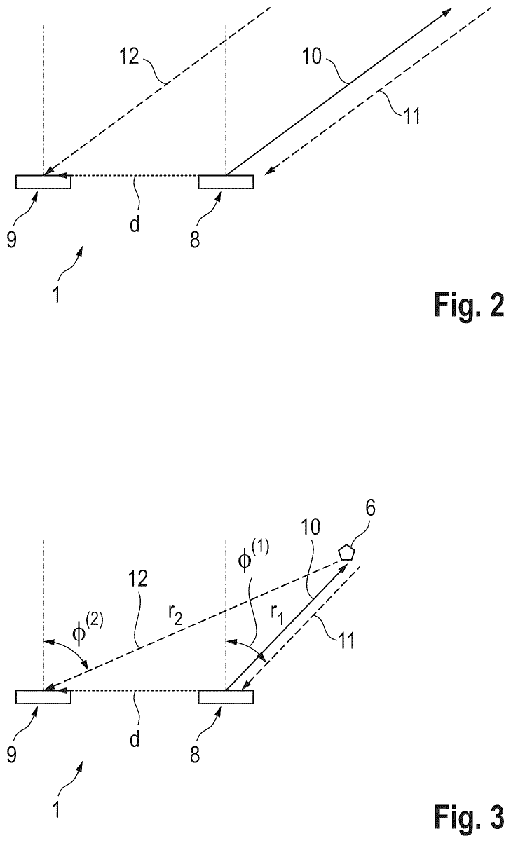

FIG. 2 and FIG. 3 illustrate two antenna arrays 8, 9, representing a first and a second antenna array, respectively.

FIG. 2 depicts the far field as the spatial area surrounding the antenna arrays 8, 9. In this scenario, the radar target 6 is located at a considerable distance from the antenna arrays 8, 9. At least one transmit signal 10 can be emitted by the first antenna array 8. This emitted signal 10 may impinge on the radar target 6 or several other radar targets and be reflected or scattered back once or multiple times. Accordingly, at least one first receive signal 11 can be received by the first antenna array 8, while a second receive signal 12 can be received by the second antenna array 9. In this case, the first antenna array 8 operates in a monostatic mode, as it both transmits and receives. Conversely, the second antenna array 9 operates in a bistatic mode, as it only receives signals. The first antenna array 8 may include at least one transmit antenna or element and a receive antenna or element. Similarly, the second antenna array 9 may comprise at least one receive element. To determine the distances and/or angles of the radar target 6 or another radar target, a transmission channel d can be established between the antenna arrays 8, 9.

This transmission channel d may, for example, function as an eavesdropping or cross-talk propagation channel, allowing the corresponding Rx and Tx elements of the two antenna arrays 8, 9 to exchange radar information or signals. In contrast to FIG. 2, FIG. 3 illustrates the spatial area of the radar system 1 in a near-field configuration. Here, the signal 10 is emitted, and the receive signals 11, 12 are accordingly received by the antenna arrays 8, 9.

Furthermore, FIG. 3 shows distances r1 and r2, representing the distances or portions of distance information between the antenna arrays 8, 9 and the radar target 6. Additionally, the angular separations of the antenna arrays 8, 9 relative to the radar target 6 are depicted. In the monostatic signal case, the antenna arrays 8, 9 may share the same local oscillator.

In an incoherent bistatic case, different or independent local oscillators can be used. In this scenario, a “soft” or “mild” synchronization between the two antenna arrays 8, 9 may suffice. Phase noise might occur during this process due to differing noise characteristics of the various local oscillators. In such cases, a larger number of virtual apertures may be employed.

In a coherent bistatic case, a cross-talk signal corresponding to the two transmissions can be mixed between the antenna arrays 8, 9. However, the distance between the two antenna arrays 8, 9 must be specified or defined with high precision.

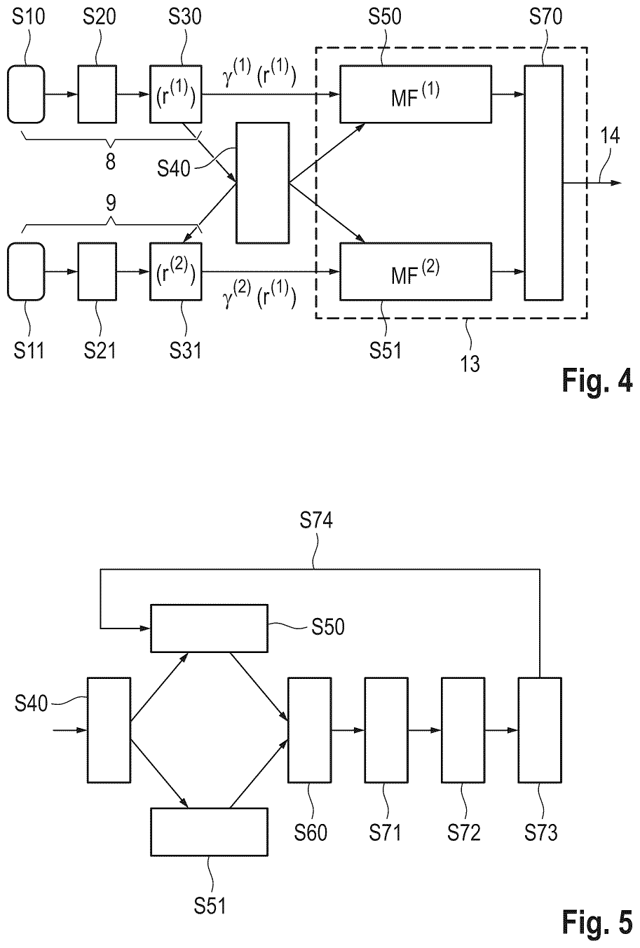

FIG. 4 illustrates a schematic representation of the flow for determining a portion of target information related to a radar target 6, as disclosed herein.

In particular, an incoherent combination of monostatic and bistatic transmit and receive signals can be executed using several antenna arrays 5, employing a generalization of an average matched filter. This approach is particularly useful for subsequent angle estimation, allowing an angle to be provided as target information 14. For this purpose, a soft synchronization of the antenna arrays 5, within the order of magnitude of the delay of a distance pin, may be employed, and the bistatic receive signals may be incoherently integrated or determined using a multiplexing method, such as TDM, which similarly requires only soft synchronization.

Initially, the received signals 11, 12 can be digitized in steps S10 and S11. Accordingly, processing operations related to the first antenna array 8 and, in a subsequent processing chain, processing or evaluation regarding the second antenna array 9 can be carried out in their respective processing paths or chains.

The digitization of the received signals 11, 12 can be performed using an analog-to-digital converter (ADC). Initially, the portions of distance information r1, r2 can be determined. For this purpose, a conventional two-dimensional FFT can be conducted. Specifically, a Fast Fourier Transform is applied to the ADC data of a respective receiver, that is, an Rx element of the corresponding antenna array 8, 9. This process may occur in steps S20 and S21. During this process, a Doppler frequency or range-Doppler frequency can be determined, which may be performed for each respective antenna array 5.

In some examples, a constant false alarm rate (CFAR) can be used or predefined for each antenna array 8, 9 in optional steps S30 and S31, enabling the detection of potential targets based on these detections. During this process, the first portion of distance information r1 can be determined, which can also be applied to the second portion of distance information r2. For example, range Doppler detections r⁽¹⁾, r⁽²⁾ can be determined or provided as possible portions of distance information r1, r2 for each antenna array 8, 9. In the process, respective detections or identifications can be ascertained either for one radar target 6 or for several radar targets. For example, based on a range Doppler detection r⁽¹⁾ and an associated first angle hypothesis Φ⁽¹⁾ of the first antenna array 8, the corresponding or appropriate range Doppler detection r⁽²⁾ as well as the associated angle hypothesis Φ⁽²⁾ can be calculated. This can be carried out above all for a plurality of possible angle hypotheses relating to the first antenna array 8.

This can be defined, for example, by way of the following formula:

(r⁽²⁾,ϕ⁽²⁾)=T(r⁽¹⁾,ϕ⁽¹⁾)

For assigning the respective data or information of the first antenna array 8 to the second antenna array 9, the antenna arrays 8, 9 must be adapted by a coordinate transform T. This can also be referred to as a preliminary extrinsic calibration. Moreover, it can be checked in a step S40 whether the associated angle hypothesis Φ⁽²⁾ is in a field of vision of the second antenna array 9. If this is the case, the process can continue with the further processing operation. Otherwise, the standard processing operation based on the first antenna array 8 is carried out, for example, for determining the target information.

The range Doppler detection r⁽²⁾ may be or may not be a detection or target detection, based on the false alarm rate relating to the second antenna array 9. In the process, the respective cases can be distinguished or considered since an aspect angle in an antenna array 5 can result in a low RCS.

A respective antenna signal γ⁽¹⁾(r₁), γ⁽²⁾(r⁽²⁾) or array signal of the first and second antenna arrays 8, 9 can be provided for further processing. A respective antenna signal or array signal γ⁽¹⁾(r₁), γ⁽²⁾(r⁽²⁾) of a respective antenna array 8, 9 can be the spectral phases over Tₓ-Rₓ pairs of the corresponding apertures or antenna arrays 8, 9 which were detected or calculated in a corresponding range Doppler detection r⁽¹⁾, r⁽²⁾.

Thereafter, a first optimal filter MF⁽¹⁾ can be determined for the first antenna array 8 in a step S50, and a second optimal filter MF⁽²⁾ can be determined in a step S51. If the optimal filters MF⁽¹⁾, MF⁽²⁾ are adapted filters or matched filters, which are adapted or determined for each antenna array 8, 9, this can be expressed as follows, for example:

MF⁽ⁱ⁾(ϕ⁽ⁱ⁾),i=1,2,

These optimal filters can be determined by means of correlation of the antenna signals with a near field model or far field model on the basis of nominal or calibrated antenna positions and point symmetries. This can take place by way of the following formula, with i denoting a respective antenna array.

MF⁽ⁱ⁾(ϕ⁽ⁱ⁾)=|(a⁽ⁱ⁾(ϕ⁽ⁱ⁾))^{H}y⁽ⁱ⁾(r⁽ⁱ⁾)|

When a near field steering vector model is used, for example, the dependence on the distance may already be included, wherein this can be described as follows:

a⁽ⁱ⁾(ϕ⁽ⁱ⁾,r⁽ⁱ⁾)

For the determination of an average or sum-adapted optimal filter, which was determined based on the two optimal filters MF⁽¹⁾, MF⁽²⁾, can be determined or calculated for the angle hypotheses Φ⁽¹⁾ and Φ⁽²⁾. This can be carried out by way of the following formula:

$$\overline{M F} ( {ϕ}^{( 1 )} ) = M {F}^{( 1 )} ( {ϕ}^{( 1 )} ) + M {F}^{( 2 )} ( {ϕ}^{( 2 )} )$$

Two alternatives are available for applying the average coincident optimal filter to a respective angle hypothesis. In one alternative, the peak values can be over the angle hypotheses Φ⁽¹⁾, Φ⁽²⁾ for every range Doppler detection r⁽¹⁾ and every corresponding reference frame of the second antenna array 9.

In the other or second alternative, an orthogonal matching pursuit algorithm 13 can be employed, in particular for the determination of the target information. This algorithm 13 may be an associated range angle block orthogonal matching pursuit (ARABOMP).

This algorithm 13 can, in particular, be iteratively carried out in a step S60. Initially, averaging of the strongest target and an iteration with the antenna signals can be carried out, which can be replaced with the residual for each distance.

In a step S60, in turn, the average optimal filter can be determined (see FIG. 5). The exact procedure of the second alternative for the evaluation of the average coincident filter will be explained again in the following FIG. 5. Initially, the further steps or previous processing operations relating to FIG. 4 are shown. However, now step S70 can be carried out subsequent to step S60. In the process, an initiated residual

u₀⁽ⁱ⁾(r⁽ⁱ⁾)=y⁽ⁱ⁾(r⁽ⁱ⁾)

can be assumed. In the process, an iteration is accordingly carried out for a respective range Doppler detection r⁽¹⁾. In the process, initially an angle hypothesis Φ⁽²⁾ can be assumed in the second antenna array 9, as stated below, for each angle hypothesis Φ⁽²⁾ and the associated distance.

(r⁽²⁾,ϕ⁽²⁾)=T(r⁽¹⁾,ϕ⁽¹⁾)

The average adapted optimal filter with the residual can be calculated as follows:

MF⁽ⁱ⁾(ϕ⁽ⁱ⁾)=|(a⁽ⁱ⁾(ϕ⁽ⁱ⁾))^{H}uₖ⁽ⁱ⁾(r⁽ⁱ⁾)

In a step S17, the angle of the strongest located target, such as for example of the radar target 6, can be determined. The following formula can be used for the determination.

ϕₖ₊₁⁽¹⁾=arg maxM̅F̅(ϕ⁽¹⁾)

In a subsequent step S72, amplitudes sₖ₊₁⁽¹⁾, sₖ₊₁⁽²⁾ can be determined for the located targets, which can be calculated by means of an orthogonal projection.

The residuals can be updated as follows in a step S73 for the corresponding distances or distance ranges:

$${u}_{k + 1}^{( 1 )} ( {r}^{( 1 )} ) := {u}_{k}^{( 1 )} ( {r}^{( 1 )} ) - {s}_{k + 1}^{( 1 )} {a}^{( 1 )} ( {ϕ}_{k + 1}^{( 1 )} ) ,$$

$${u}_{k + 1}^{( 2 )} ( {r}^{( 2 )} ) := {u}_{k}^{( 2 )} ( {r}^{( 2 )} ) - {s}_{k + 1}^{( 2 )} {a}^{( 2 )} ( {ϕ}_{k + 1}^{( 2 )} ) .$$

If the magnitude of the array signal residue is smaller than a certain threshold value for the corresponding distance band, the search for an angle for this distance is aborted.

In a step S74, in turn, runs can again be performed for k+1 iterations. So as to be able to efficiently carry out the determination of the radar target 6, and in particular of the target information, such as of the corresponding angle, it can be checked whether the first antenna array 8 is intrinsically calibrated.

Further exemplary embodiments will be described hereafter.

If the first antenna array 8 is intrinsically calibrated and, for example, the second antenna array 9 is not, a cooperative intrinsic auto-calibration method can optionally be used, in which the first antenna array 8 either supplies an angle estimation or the angle estimation is carried out together with the estimation and symmetry of the second antenna array 9. In the latter case, the joint optimization can be described as follows in the case of the radar target 6:

$${ϕ}^{( 1 )} , {ψ}^{( 2 )} = arg max M {F}^{( 1 )} ( {ϕ}^{( 1 )} ) + \vert {( D ( {ψ}^{( 2 )} ) {a}^{( 2 )} ( {ϕ}^{( 2 )} ) )}^{H} {y}^{( 2 )} ( {r}^{( 2 )} ) \vert$$

Here, a⁽²⁾(ϕ⁽²⁾) can include the far or near field longitudinal vector model, and D(ω⁽²⁾) is defined as follows with respect to the phase unbalance of the Tx and Rx channels:

$${ψ}_{T x}^{( 2 )} = ( {ψ}_{T {x}_{1}} , … , {ψ}_{T {x}_{N}} ) , {ψ}_{R x}^{( 2 )} = ( {ψ}_{R {x}_{1}} , … , {ψ}_{R {x}_{M}} ) .$$

$$D ( {ψ}^{( 2 )} ) := exp ( j diag ( {ψ}_{T x}^{( 2 )} ⊗ {ψ}_{R x}^{( 2 )} ) )$$

Here, it must be noted that the optimization via ϕ⁽¹⁾ suffices since ϕ⁽²⁾ is a function of ϕ⁽¹⁾ according to the target association

(r⁽²⁾,ϕ⁽²⁾)=T(r⁽¹⁾,ϕ⁽¹⁾).

Possible advantages of the cooperative calibration in the case of a small calibrated antenna array and a large uncalibrated antenna array are at least a controlled scenario or a controlled situation in which the same target group shares a range field and the associated range field in the other antenna arrays. Considering an antenna array 5 that is composed of a large array having a large product of transmit-receive elements, combined with a small antenna array, the large antenna array benefits from measurements, but the resolution is too high, and it may be very sensitive for the DOA estimation (angle estimation). If positions are known, joint estimations of phases and angles can be carried out more easily for smaller arrays. The average matched filter (that is, the average of the angle spectra) benefits from a low sensitivity to the angle estimation due to the average resolution. This means that the adapted angle of the small antenna array acts in the manner of a smoother or regulator. This can be an advantage compared to a simple forwarding of a previous estimation.

When the large antenna array, due to the resolution, sees or detects two or more targets, the smoothing effect helps to automatically group these, which is also of advantage for the angle estimation, thus in particular at least for the estimation of the phases, while the optional estimation of the antenna position of individual antenna elements results from a large number of measurements. Another advantage compared to the tapering of the amplitude is that the average adapted filter does not experience any SMR loss, as it does with the tapering, and benefits from the previously calibrated antenna array.

As described above, different steering vector models can be used. The formulas described hereafter describe an array control vector model for a respective antenna array, wherein for the simplification of the super indices a=a⁽ⁱ⁾ is omitted to provide a better understanding.

Hereafter, the model of the steering vector in the near field, that is, in the spherical wave front, is described. In the near field, the reception control vector results for a receiver that is located in the receiving range {pᵢ=[xᵢ,yᵢ,zᵢ]} at an angle ϕ, θ by the distance r:

$${[ {a}_{R x} ( ϕ , θ , r ) ]}_{i} = exp ( - j \frac{2 π}{λ} r \sqrt{1 - \frac{2}{r} {n}^{T} {p}_{i} + \frac{{p}_{i}^{T} {p}_{i}}{{r}^{2}}} )$$

### Here,

n:=[cos(θ)cos(ϕ),cos(θ)sin(ϕ),sin(θ)]

can be used to predefine the target direction. Due to the reciprocity of transmission and reception, the transmission control vector

a_{Tx}(ϕ,θ,r)

is analogous to the transmission locations.

The array signal model for the virtual Tx-Rx pairs is defined as follows:

$$a ( ϕ , θ , r ) := {a}_{T x} ( ϕ , θ , r ) ⊗ {a}_{R x} ( ϕ , θ , r ) ,$$

⊗ refers to the Kronecker product.

In the bistatic scenario in which the transmitter and the receiver, that is, transmitting elements and receiving elements of the antenna arrays 5, are located in different antenna arrays, the frame of reference can be related to the transformation from the extrinsic calibration. In the case where the transmitters are located in the first antenna array 8, and the receivers are located in the second antenna array 9, this can be described, for example, as follows:

$${[ {a}_{R x} ( ϕ , θ ) ]}_{i} = exp ( j \frac{2 π}{λ} {n}^{T} {p}_{i} ) ,$$

wherein
(r⁽²⁾,ϕ⁽²⁾,θ⁽²⁾)=T(r⁽¹⁾,ϕ⁽¹⁾,θ⁽²⁾) applies.

Hereafter, the far field control vector model, that is, in the plane wave front, is described. In the far field, the control vector or the array signal is simplified either by the transmission or the receiver to

$${[ {a}_{R x} ( ϕ , θ ) ]}_{i} = exp ( j \frac{2 π}{λ} {n}^{T} {p}_{i} ) .$$

In the monostatic case, the combined control vector of transmit and receive is defined as follows:

$$a ( ϕ , θ ) := {a}_{T x} ( ϕ , θ ) ⊗ {a}_{R x} ( ϕ , θ ) = exp ( j \frac{2 π}{λ} {n}^{T} {p}_{virt} )$$

where
pᵥᵢᵣₜ=p_{Tx}⊕p_{Rx}, wherein here the Kronecker sum ⊕ is taken into consideration.

In the bistatic case, the plane wave fronts are viewed from the perspective of each antenna array, and a relation of the intrinsic calibration transformation, as in the near field case, can be established.

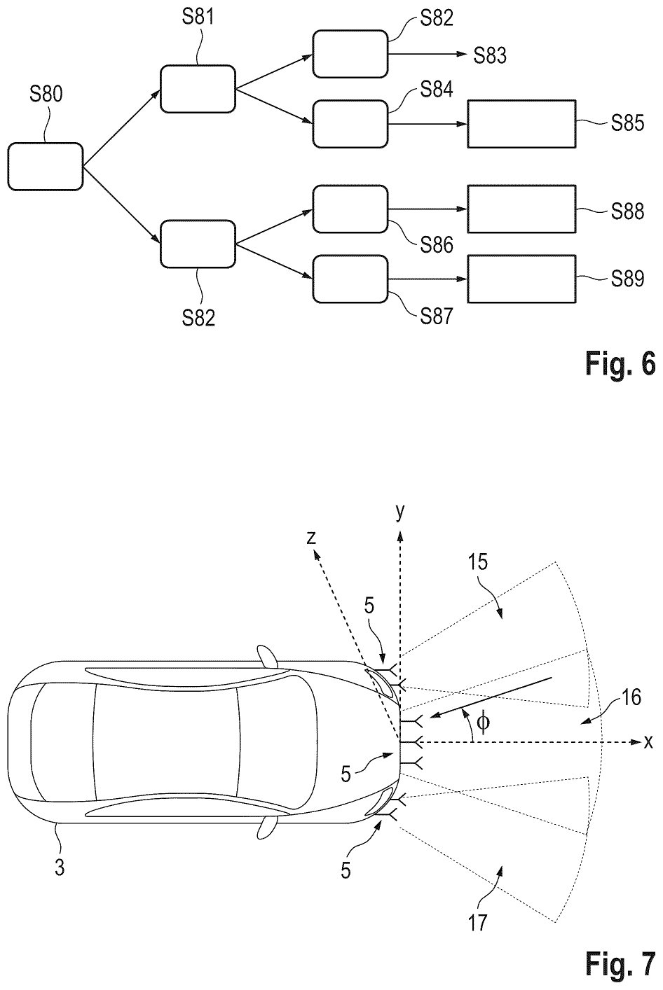

FIG. 6 describes the method according to the invention in other locations.

Initially, in a step S80 the portion (piece) of distance information r₍₁₎ or the range Doppler detection r⁽¹⁾ can be ascertained. In the process, it can again be checked whether the range Doppler detection or the target detection of the second antenna array 9 corresponds to the first antenna array 8, such as corresponds with the condition r₍₁₎⁽¹⁾=r₍₂₎⁽¹⁾. Thereafter, a distinction can be made depending on whether it is a near field detection or a far field detection. In step S81, the processing with respect to the portions of information for a near field is performed, and in step S8 the processing for a far field is, in turn, performed. After step S81, it may have been established in a step S82 that the second antenna array 9 has different range pins compared to the first antenna array 8. This may, in turn, not be the case so that the process can be aborted here in a step S83. When, in turn, the second antenna array 9 has the same range pins as the antenna 1, as can be established with the condition r₍₁₎⁽²⁾=r₍₂₎⁽²⁾. This can take place in a step S84. Thereafter, in a step S85, the SMR can be amplified again, and the further calculation can be performed by means of the algorithm 13.

If the process continues to step S82, and the scenario involves a far field, it can be checked in step S86 whether the portions of distance information from the first antenna array 8 and the second antenna array 9 are identical. If they are, side lobe suppression can be improved in step S88, as the second antenna array 9 has also identified the radar target 6, allowing further targets to be identified. If it is determined in step S87 that the portions of distance information from the two antenna arrays 8, 9 are identical, the SMR can be amplified in step S89, and the procedure of algorithm 13 can begin or continue.

In other words, when the radar target 6 or multiple radar targets are detected by each antenna array 8, 9, and the detection includes a portion of distance information, the ARABOMP method can be employed to locate the strongest target, which can then be removed from the portions of distance information or range fields. The obscuration of side lobes can be reduced, especially due to ongoing updates, and the resolution can be correspondingly increased. It should be noted that a scenario of a joint distance range and joint far angle can occur when the targets are symmetrically positioned relative to one antenna array over or behind the other antenna array.

The vehicle 3 can be seen again in the following FIG. 7. In this figure, different visual ranges 15, 16, 17 for various antenna arrays 5 are represented. The antenna arrays 5 are arranged so that the visual ranges or fields of vision 15 to 17 overlap to cover the largest possible area using sensors. Each visual range 15 to 17 can be provided for different angles or angle hypotheses.

Subsequently, intrinsic calibration of a respective target detection or target acquisition can be carried out using calibration targets, particularly before the radar is operated, to perform a coordinate transformation between the reference systems of the antenna arrays 5. In this process, possibly unknown relative position orientations of the antenna arrays 5 due to manufacturing or assembly tolerances can be taken into account. One advantage is that the coordinate transformation does not require wavelength accuracy, as the information is combined at the level of spectra or supported by absolute filters. The transformation T is calculated only once, but for the range pin or each antenna array 5. For simplicity, this transformation is expressed in polar coordinates, such as:

(r⁽²⁾,ϕ⁽²⁾)=T(r⁽¹⁾,ϕ⁽¹⁾).

However, it is also possible for an adaptation in Cartesian coordinates to occur. The disclosed method for target detection or the determination of portions of target information applies to any two-dimensional or three-dimensional geometries unless the coupling between the antenna arrays 5 does not occur within each antenna array 5. It is possible to consider or use far or near field models a⁽¹⁾a⁽²⁾.

In the case of uniform arrays, antenna arrays 5, or antenna arrays with specific symmetries, standard smoothing methods can be incorporated for target decorrelation.

Furthermore, it must be noted that the signals y⁽¹⁾(r⁽¹⁾), y⁽²⁾(r⁽²⁾) of the two antenna arrays 8, 9 correspond to the spectral phases after the range Doppler processing for the selected range for all virtual Tx-Rx pairs in each antenna array 8, 9. Including the measurements with Tx and Rx in various apertures is optional since the downmixing with a different local oscillator than that which is used for the transmission is known to increase phase noise.

For example, a soft synchronization between the local oscillators can be implemented, meaning these oscillators are not synchronized for wavelength accuracy but for the accuracy of the range pins. Additionally, synchronization can be achieved with the time delay between the range pins, where, for example, 15 cm corresponds to 15 ns. In contrast, the synchronization with the time of a carrier wavelength at 77 GHz is 13 ps. It is also not necessary for local oscillator signals to be transmitted between the antenna arrays 5, as it is much simpler to use independent local oscillators, which can be synchronized more easily. The MIMO pattern for avoiding interferences between transmitters includes the commonly used time multiplexing method, which similarly requires soft synchronization between the antenna arrays.

A decentralized calculation can be performed, for instance, in the FPGA of each sensor. During this process, range allocation between the antenna arrays can be provided for each angle hypothesis. Following this, the average matched filter across all antenna arrays can be calculated. The front ends, meaning the antenna arrays, do not have any particular requirements and can function as sparsely configured arrays.

The averaging of side lobes may presuppose that the radar target 6 has a similar SMR at both antenna arrays and can generate side lobes for sparse array configurations, potentially leading to the obscuration of targets with different radar cross-sections. When using the orthogonal matching pursuit, side lobes from strong targets can be eliminated. However, the side lobe level should be reduced in this process.

The disclosed technology can also be applied to coherent processing. Thus, it is possible to combine this approach with coherent systems that use one or more local oscillators, phase lock loop modules, either electrical or optical.

Other synchronization systems, quasi-synchronization systems, and/or algorithms that enable quasi-coherent processing with phase adaptation/unbalance estimation in various frameworks can also be considered. In particular, this disclosure demonstrates how a radar system with distributed apertures can be used for monostatic and/or bistatic signal processing, where the individual apertures are positioned unevenly or sparsely relative to one another. As a result, the radar system 1 can be especially useful in dynamic applications such as motor vehicles, trains, aircraft, or ships.

The disclosed technology and techniques for determining portions of target information within a radar system are particularly applicable in vehicle systems, such as advanced driver assistance systems (ADAS) and autonomous driving technologies. This technology can be integrated into a vehicle's radar system to enhance the detection and tracking of objects within the vehicle's environment, including other vehicles, pedestrians, and obstacles. By utilizing the capability to process both monostatic and bistatic radar signals through distributed antenna arrays, the radar system achieves improved accuracy in determining the position and movement of these objects. This accuracy is crucial for vehicle functions such as adaptive cruise control, lane-keeping assistance, collision avoidance, and automated parking. The technology supports soft synchronization of local oscillators and decentralized calculations within the vehicle's sensors, enabling real-time data processing essential for the vehicle's safe operation. When applied within the vehicle context, the radar system directly contributes to enhanced vehicle safety and functionality, ensuring reliable operation in dynamic driving conditions.

### LIST OF REFERENCE NUMERALS

1 radar system
2 environment
3 vehicle
4 electronic evaluation unit
5 antenna arrays
6 radar target
7 driving direction
8, 9 first and second antenna arrays
10 transmit signal
11, 12 first and second receive signals
13 orthogonal matching pursuit algorithm
14 target information
15 to 17 fields of vision
S10 to S89 steps
d transmission channel
r₍₁₎, r₍₂₎ first, second portion (piece) of distance information
Φ⁽¹⁾, Φ⁽²⁾ first, second angle hypothesis
Φ angle or azimuth angle
n distance
θ polar angle
r⁽¹⁾, r⁽²⁾ range Doppler detection
MF⁽¹⁾, MF⁽²⁾ first and second optimal filters
γ⁽¹⁾(r⁽¹⁾), γ⁽²⁾(r⁽¹⁾) first and second antenna signal

1. A method for determining portions of target information of radar targets within a radar system, the method comprising:
emitting a transmit signal into an environment via a first antenna array of the radar system;
receiving, via the first antenna array, a first receive signal that is based on the emitted transmit signal and is reflected by a radar target in the environment;
receiving, via a second antenna array that differs from the first antenna array, a second receive signal that is based on the emitted transmit signal and is reflected by the radar target in the environment;
determining, based on the transmit signal and the first receive signal, a first portion of distance information between the first antenna array and the radar target;
providing a first angle hypothesis for the first antenna array as a function of the first portion of distance information;
determining, based on the first portion of distance information and the first angle hypothesis, a second portion of distance information and a second angle hypothesis corresponding thereto for the second antenna array;
determining a first optimal filter based on the first portion of distance information and the first angle hypothesis, and/or determining a second optimal filter based on the second portion of distance information and the second angle hypothesis; and
determining a portion of target information related to the radar target based on the first and/or second optimal filters.

2. The method according to claim 1, wherein the determining of the first portion of distance information comprises determining the first portion of distance information based on a Fast Fourier transform.

3. The method according to claim 1, wherein the determining of the first portion of distance information comprises determining the first portion of distance information based on a constant false alarm rate relating to the first antenna array.

4. The method according to claim 1, wherein the determining of the second portion of distance information and the second angle hypothesis for the second antenna array comprises carrying out an extrinsic calibration on the first and/or second antenna arrays.

5. The method according to claim 1, further comprising checking whether the first antenna array has been intrinsically calibrated, and if so, calibrating the second antenna array as a function of the calibrated first antenna array using a cooperative auto-calibration method.

6. The method according to claim 1, further comprising:
checking whether the determined second angle hypothesis is within a field of vision of the second antenna array; and
if the second angle hypothesis is within the field of vision, determining the portion of target information based on the first and second optimal filters; and
if the second angle hypothesis is outside the field of vision, determining the portion of target information based on the first optimal filter.

7. The method according to claim 1, wherein the determining of the first and second antenna signals comprises determining a first antenna signal of the first antenna array based on the first portion of distance information and antenna information relating to antenna elements of the first antenna array, and determining a second antenna signal of the second antenna array based on the second portion of distance information and antenna information relating to antenna elements of the second antenna array.

8. The method according to claim 7, wherein:
the determining of the first optimal filter comprises determining the first optimal filter of the first antenna array based on the first antenna signal and a predefined model of a spatial area of the first antenna array, and taking nominal or calibrated antenna positions and/or phase unbalances of the first antenna array into consideration during the determination of the first optimal filter; and
the determining of the second optimal filter comprises determining the second optimal filter of the second antenna array based on the second antenna signal and a predefined model of a spatial area of the second antenna array, and taking nominal or calibrated antenna positions and/or phase unbalances of the second antenna array into consideration during the determination of the second optimal filter.

9. The method according to claim 8, wherein the determining of the first and second optimal filters comprises providing a near field vector model or a far field vector model as a predefined model of the spatial area of the first and second antenna arrays.

10. The method according to claim 7, further comprising filtering the first antenna signal by the first optimal filter and filtering the second antenna signal by the second optimal filter, and determining the portion of target information based on the filtered first and second antenna signals.

11. The method according to claim 10, wherein the determining of the portion of target information is based on an orthogonal matching pursuit algorithm.

12. The method according to claim 1, wherein the determining of the portion of target information comprises providing an angle with respect to and/or a direction to the radar target.

13. A radar system comprising:
a first antenna array configured to emit a transmit signal into an environment and receive a first receive signal that is based on the emitted transmit signal and is reflected by a radar target in the environment;
a second antenna array, different from the first antenna array, configured to receive a second receive signal that is based on the emitted transmit signal and is reflected by the radar target in the environment; and
an electronic evaluation unit configured to:
determine, based on the transmit signal and the first receive signal, a first portion of distance information between the first antenna array and the radar target;
provide a first angle hypothesis for the first antenna array as a function of the first portion of distance information;
determine, based on the first portion of distance information and the first angle hypothesis, a second portion of distance information and a second angle hypothesis corresponding thereto for the second antenna array;
determine a first optimal filter based on the first portion of distance information and the first angle hypothesis, and/or determine a second optimal filter based on the second portion of distance information and the second angle hypothesis; and
determine a portion of target information related to the radar target based on the first and/or second optimal filters.

14. The radar system according to claim 13, wherein the electronic evaluation unit is configured to determine the first portion of distance information based on a Fast Fourier transform.

15. The radar system according to claim 13, wherein the electronic evaluation unit is configured to determine the first portion of distance information based on a constant false alarm rate relating to the first antenna array.

16. The radar system according to claim 13, wherein the electronic evaluation unit is configured to determine the second portion of distance information and the second angle hypothesis for the second antenna array by carrying out an extrinsic calibration on the first and/or second antenna arrays.

17. The radar system according to claim 13, wherein the electronic evaluation unit is further configured to:
check whether the first antenna array has been intrinsically calibrated, and if so,
calibrate the second antenna array as a function of the calibrated first antenna array using a cooperative auto-calibration method.

18. The radar system according to claim 13, wherein the electronic evaluation unit is further configured to:
check whether the determined second angle hypothesis is within a field of vision of the second antenna array; and
if the second angle hypothesis is within the field of vision, determine the portion of target information based on the first and second optimal filters; and
if the second angle hypothesis is outside the field of vision, determine the portion of target information based on the first optimal filter.

19. The radar system according to claim 13, wherein the electronic evaluation unit is configured to:
determine a first antenna signal of the first antenna array based on the first portion of distance information and antenna information relating to antenna elements of the first antenna array, and
determine a second antenna signal of the second antenna array based on the second portion of distance information and antenna information relating to antenna elements of the second antenna array.

20. A method for determining target information of radar targets in a radar system, the method comprising:
emitting a signal into an environment via a first antenna array of the radar system;
receiving, via the first antenna array, a first signal reflected by a radar target in the environment;
receiving, via a second antenna array that is different from the first antenna array, a second signal reflected by the radar target;
processing the first and second signals to determine distance information and an angle hypothesis for the radar target; and
applying at least one optimal filter based on the distance information and the angle hypothesis to determine target information related to the radar target.
